(19) United States
(12) Patent Application Publication
(10) Pub. No.: US 2009/0280833 A1
(43) Pub. Date: Nov. 12, 2009

(54) METHOD AND SYSTEM FOR PROVIDING INFORMATION ASSOCIATED WITH PREVIOUSLY VISITED LOCATIONS

(75) Inventors: JORGE L. PERDOMO, BOCA RATON, FL (US); DANIEL A. BAUDINO, LAKE WORTH, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 12/118,869

(22) Filed: May 12, 2008

(51) Int. Cl. H04Q 7/20

(52) U.S. Cl. 455/456.3

(57) ABSTRACT

A method and system of providing information associated with a previously visited location. The method can include the steps of monitoring the location of the mobile unit, receiving at the mobile unit information from one or more points of interest as the mobile unit engages the points of interest in which the information is associated with the points of interest and storing the information associated with the points of interest in a database that is accessible for a predetermined amount of time after the receipt of the information. The method can also include the step of storing the information into one of a predetermined number of categories based on how the mobile unit engages the points of interest.

### BACKGROUND OF THE INVENTION

1. Field of the Invention

The claimed subject matter concerns providing information concerning locations and more particularly, providing information associated with locations that have been previously visited.

2. Description of the Related Art

Users of mobile units are becoming more reliant on such devices to provide relevant information. To meet this demand, manufacturers of mobile devices are frequently adding new features, such as Global Positioning System (GPS) services, Web browsers and increased bandwidth capabilities. Concerning the GPS services, a user can enter a physical address, and the mobile device will provide a suggested route and will display the user's progress as the handset moves along the recommended path. In addition, if the user's destination is a business, the mobile unit may display information associated with the establishment or that of other concerns in the targeted area. Moreover, a users' handset may provide information about certain businesses based on the user's inquiry. For example, a user may request the location of a seafood restaurant that is within walking distance of the user's location. These known services, however, focus only on the user's current or future destination.

### SUMMARY OF THE INVENTION

A method and system of providing information associated with a previously visited location is described herein. In one arrangement, the method can include the steps of monitoring the location of the mobile unit and receiving at the mobile unit information from one or more points of interest as the mobile unit engages the points of interest. The information can be associated with the points of interest. The method can also include the step of storing the information associated with the points of interest in a database that is accessible for a predetermined amount of time after the receipt of the information.

In one arrangement, the information can be stored in one of a predetermined number of categories based on how the mobile unit engages the points of interest. For example, one of the categories is a first category that can be based on (1) the user of the mobile unit being at a point of interest greater than a predetermined amount of time; (2) the user having a scheduled appointment at a point of interest; (3) whether the user of the mobile unit purchased an item at a point of interest; (4) the frequency at which the user of the mobile unit visits a point of interest; or (5) the user of the mobile unit listing a point of interest as worthy of storage in the first category. As another example, one of the categories is a second category that can be based on the mobile unit being at a point of interest less than a predetermined amount of time. As yet another example, one of the categories is a third category that can be based on how recently the mobile unit engages a point of interest.

The method can also include the step of filtering the receipt of information at the mobile unit such that information from only certain types of points of interest are stored in the database. Also, the information can be stored in a database of a memory of the mobile unit or in a database of a memory of another device, and the method can include the step of accessing the information stored in the database at the mobile unit or at the other device. The method can further include the step of removing the information associated with the points of interest from the database after the predetermined amount of time.

As an example, the information can include a name of a business, a contact number, a Web site address, a physical address, hours of operation, a menu, accepted payment methods or type of items sold. The points of interest can include, for example, commercial establishments, residences or advertising structures. In one arrangement, the information from one or more points of interest can be received over a short-range or near-field communication protocol.

A method and system of displaying points of interest is also described herein. The method can include the steps of recording a path of transit that a mobile unit has taken over the course of a predetermined amount of time or distance and receiving information from one or more points of interest that are within an acceptable range of the path of transit. The information can be associated with the points of interest. The method can also include the steps of storing the information associated with the points of interest in a database and displaying the information associated with the points of interest in a reverse chronological order when the information is accessed from the database. The method can also include the steps of sorting the information associated with the points of interest based on a degree of interaction between the mobile unit and a point of interest and selectively blocking the receipt of information from points of interest that are designated as unwanted.

A mobile unit for providing information associated with a previously visited location is also described herein. The mobile unit can include a location tracking unit that monitors the location of the mobile unit and a transceiver that receives information from one or more points of information when the mobile unit engages the points of interest. As noted earlier, the information can be associated with the points of interest. The mobile unit can also include a processor that can be communicatively coupled to the location tracking unit and the transceiver. In one arrangement, the processor can be operable to push the information associated with the points of interest to a database and provide access to the information for a predetermined amount of time following the receipt of the information at the transceiver.

As an example, the database can be contained within the mobile unit or the database may be part of another device. The mobile unit can also include a filter that selectively blocks the receipt of information from undesirable points of interest. In another arrangement, the mobile unit can include a display that shows the information associated with the points of interest in a reverse chronological order based on a path that the mobile unit travels along. As another example, the mobile unit engaging the points of interest can be based on a degree of interaction between the mobile unit and a point of interest.

### BRIEF DESCRIPTION OF THE DRAWINGS

Features that are believed to be novel are set forth with particularity in the appended claims. The claimed subject matter may best be understood by reference to the following description, taken in conjunction with the accompanying drawings, in the several figures of which like reference numerals identify like elements, and in which:

FIG. 1 illustrates an example of a system for providing information associated with a previously visited location;

FIG. 2 shows an example of a block diagram of a mobile unit; and

FIG. 3 illustrates an example of a method of providing information associated with a previously visited location.

### DETAILED DESCRIPTION

As required, detailed embodiments of the claimed subject matter are disclosed herein; however, it is to be understood that the disclosed embodiments are merely exemplary and can be embodied in various forms. Therefore, specific structural and functional details disclosed herein are not to be interpreted as limiting, but merely as a basis for the claims and as a representative basis for teaching one skilled in the art to variously employ the claimed subject matter in virtually any appropriately detailed structure. Further, the terms and phrases used herein are not intended to be limiting but rather to provide an understandable description.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The terms “coupled” or “communicatively coupled” as used herein are defined as connected, although not necessarily directly, and not necessarily mechanically.

The term “transceiver” can be defined as any component or group of components that is capable of receiving and/or transmitting communications signals. The term “processor” can mean any component or group of components, including any suitable combination of hardware and software, that is capable of carrying out any of the processes described herein. The term “mobile unit” can mean any portable communication unit capable of at least receiving transmissions. The term “information” can mean any type of data, facts, intelligence or advice that is capable of being transmitted to a mobile unit. A “database” can be any collection of data organized for convenient access.

A method and system of providing information associated with a previously visited location is disclosed herein. The method can include the steps of monitoring the location of the mobile unit and receiving at the mobile unit information from one or more points of interest as the mobile unit engages the points of interest in which the information is associated with the points of interest. The method can further include the steps of storing the information associated with the points of interest in a database that is accessible for a predetermined amount of time after the receipt of the information. The information associated with the points of interest can be stored in one of a predetermined number of categories based on how the mobile unit engages the points of interest. This process can permit a user to review information, such as contact numbers, types of items sold or hours of operation, that was received from one or more previously visited sites or establishments should the user wish to access this information in the future.

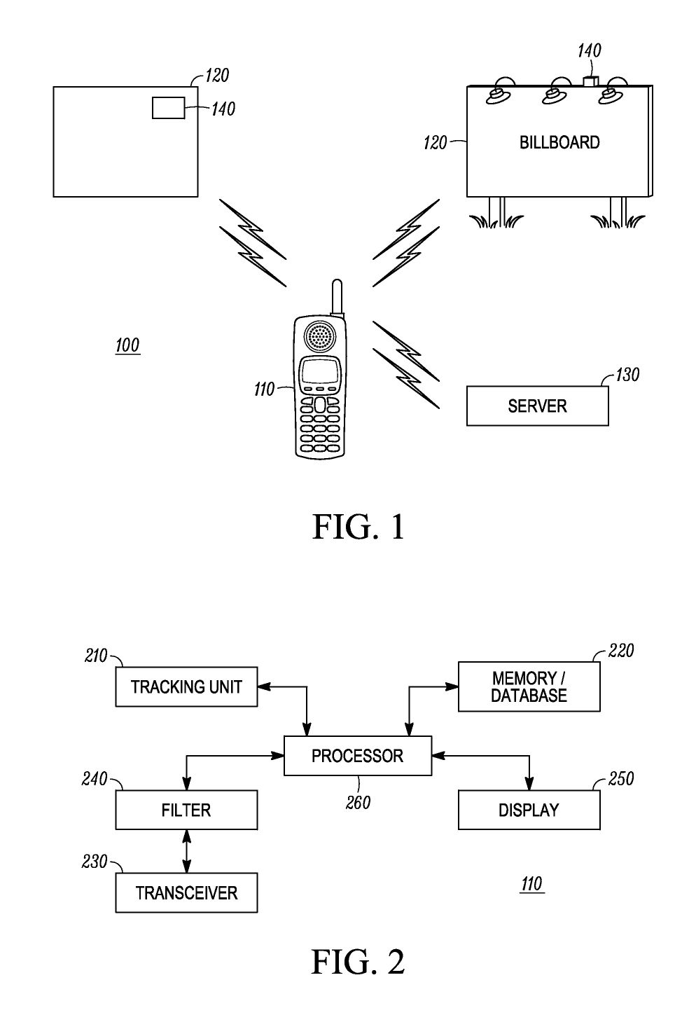

Referring to FIG. 1, a system 100 for providing information associated with previously visited sites is shown. As an example, the system 100 can include a mobile unit 110, one or more points of interest 120 and another unit 130, such as a server or other mobile unit, that is capable of storing and providing access to relevant data. Each of the points of interest 120 may include a transceiver 140 that is capable of transmitting wireless signals to the mobile unit 110. A point of interest can be defined as any structure that has one or more components capable of communicating with a mobile unit and that may be of interest to an operator of such a mobile unit. Suitable examples of points of interest 120 include commercial establishments, like grocery stores, restaurants, medical or dental offices or other professional service businesses. Another example of a point of interest 120 is an advertising structure, like a billboard or signs on a city bus or taxi. A point of interest 120 can even include a residence, such as a single family home or an apartment complex. It must be understood, however, that a point of interest is in no way limited to these particular examples.

Referring to FIG. 2, an example of a mobile unit 110 is shown. The mobile unit 110 can include a tracking unit 210, a memory 220 that can store any suitable number of databases, a transceiver 230, a filter 240, a display 250 and a processor 260, which can be coupled to one or more of the components listed above. The tracking unit 210 can receive signals from any suitable location tracking system, such as Global Positioning System (GPS), and can provide the location of the mobile unit 110 to the processor 260. The processor 260 can maintain a log that lists the tracking data captured by the tracking unit 210.

The memory 220 can provide suitable storage for information received by the mobile unit 110, such as information that is associated with one or more points of interest 120. As will be explained later, this information can be categorized into one or more databases in the memory 220. The transceiver 230 can receive wireless signals that are transmitted by the transceivers 140 of the points of interest. As an example, the wireless signals received by the transceiver 230 of the mobile unit 110 can be short-range or near-field signals, such as those transmitted in accordance with protocols like Bluetooth, Wi-Fi, ZigBee or asynchronous systems including MotoTalk. Of course, these signals can be transmitted using wide area or long-range transmissions, if desired, and the transceiver 230 can be correspondingly configured to handle them.

The filter 240, which can be any suitable combination of hardware and software, can block the receipt of unwanted transmissions, such as those from establishments that do not qualify as a point of interest 120 or that are unwanted by the user of the mobile unit 110. Additionally, the display 250 can display the information received from one or more points of interest 120 in a predetermined fashion. Suitable examples of how this information can be displayed will be described later.

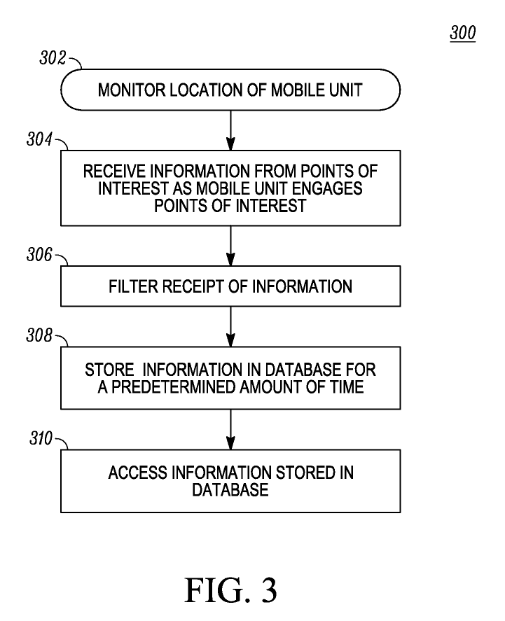

Turning to FIG. 3, a method 300 of providing information associated with a previously visited location is shown. To describe this method 300, reference will be made to FIGS. 1 and 2, although it is understood that the method 300 can be practiced in any other suitable system using any other suitable components. Moreover, the steps of the method 300 are not limited to the particular order in which they are presented in the figure. Also, the method 300 can have a greater number of steps or a fewer number of steps than those shown in the figure.

At step 302, a location of a mobile unit can be monitored, and at step 304, information can be received from points of interest as the mobile unit engages the points of interest. The receipt of this information can be filtered (if desired), as shown at step 306, and at step 308, the information can be stored in a database for a predetermined amount of time. At step 310, the information stored in the database can be accessed. Examples of these steps will be described below.

Referring to FIGS. 1 and 2, the tracking unit 210 of the mobile unit 110 can monitor the location of the mobile unit 110, and this data can be stored in the processor 260 or some other suitable component. As such, a path of transit that the mobile unit 110 has taken can be recorded, and this path of transit can be recorded over a predetermined amount of time or distance. As the mobile unit 110 is in transit, information from one or more points of interest 120 can be received at the mobile unit 110 as the mobile unit 110 engages the points of interest 120, and this information can be associated with the points of interest 120. A mobile unit engaging a point of interest can mean any interaction between a mobile unit and communication equipment that is part of or associated with a point of interest. Because the interaction may be based on the ability of the mobile unit 110 to receive signals from communications equipment that is part of the points of interest 120, the information can be received from points of interest 120 that are within an acceptable or predetermined range of the path of transit that the mobile unit 110 takes.

The type of information that is received from the points of interest 120 can take many forms. For example, the information may include a name of a business, a contact number, a Web site address, a physical address, hours of operation, a menu, accepted payment methods or types of items sold at a point of interest 120. Those of skill in the art will appreciate that the above list is not intended to be exhaustive, as other suitable types of data may be included in the received information.

In one arrangement, the filter 240 of the mobile unit 110 may be configured to filter the receipt of information such that information from only certain types of points of interest 120 are accepted. That is, the filter 240 can selectively block the receipt of information from points of interest 120 that are designated as unwanted. For example, a user may not want to receive information that is transmitted from an advertising structure—such as a billboard—or from unknown residences or certain commercial establishments.

Information from the points of interest 120 that is accepted at the mobile unit 110 can be stored in a database, such as one that is part of the memory 220 of the mobile unit 110. Alternatively, the mobile unit 11 0 can push the information to another device, like the unit 130. As noted earlier, the unit 130 may be, for example, a server or another mobile unit. If the information is to be stored at the unit 130, the user of the mobile unit 110 can be given access to the unit 130. In one arrangement, the information that is stored may be accessible for a predetermined amount of time after the receipt of the information. For example, the information may be stored for a week or month after its receipt, depending on various factors, including available memory and the wishes of the user of the mobile unit 110. Once the predetermined amount of time expires, the information to be deleted can be written over with more recent information.

The information can be stored in one of a predetermined number of categories based on how the mobile unit 110 engages the points of interest 120. That is, the information associated with the points of interest can be sorted based on a degree of interaction between the mobile unit 110 and a point of interest 120. One of the categories can be a first category that relates to a higher degree of interaction between the mobile unit 110 or the user of the unit 110 and a point of interest 110. Examples of factors that determine whether received information is to be placed in this first category include (1) the user of the mobile unit 110 being at a point of interest 120 greater than a predetermined amount of time; (2) the user having a scheduled appointment at a point of interest 120; (3) whether the user of the mobile unit 110 purchased an item at a point of interest 120; (4) the frequency at which the user of the mobile unit 110 visits a point of interest 120; or (5) the user of the mobile unit 110 listing a point of interest 120 as worthy of storage in the first category.

A second category can exist in which the degree of interaction between the mobile unit 110 or the user of the mobile unit 110 and the point of interest is less than that involved with the first category. An example of a factor that determines whether information from a point of interest 120 is to be stored in this second category is whether the mobile unit 110 (and presumably, the user of the mobile unit 110) was at a point of interest 120 for less than a predetermined amount of time. A third category may also be available into which the information associated with a point of interest 120 is stored based on how recently the mobile unit 110 engaged the point of interest 120. Several non-limiting examples will be presented here.

Consider the following scenario. A user of a mobile unit 110 has an appointment scheduled at a doctor's office. As the user makes her way to the office, the tracking unit 210 of the user's mobile unit 110 monitors the location of the mobile unit 110. The mobile unit 110, during the path of transit, may pass by a first point of interest 120, which can be a billboard, and the billboard may transmit to the mobile unit 110 information associated with a company whose products are being advertised on the billboard. Subsequently, the mobile unit 110 may pass by a second point of interest 120, which can be a gift shop, and information associated with the gift shop can be transmitted to the mobile unit 110. The user may also stop at a third point of interest 120, such as a restaurant, and can make a purchase there. Again, information can be transmitted from the restaurant to the mobile unit 110. Finally, the user can reach the doctor's office (fourth point of interest 120) thereby completing the trip, and this fourth point of interest 120 can transmit relevant information to the user's mobile unit 110.

In accordance with the exemplary categories described above, the information associated with the first and second points of interest 120 (i.e., the billboard and the gift shop) can be stored in the second category, as the amount of time spent at these locations was merely transitory in nature. The information associated with the third and fourth points of interest 120 (i.e., the restaurant and the doctor's office), however, can be stored in the first category, as the user spent a considerable amount of time at both locations, had an appointment at the doctor's office and purchased items at the restaurant. It should also be noted that the information associated with all these points of interest 120 may be sorted into the third category, as the interactions all occurred very recently.

It should also be noted that the received information can be grouped into categories based on criteria other than that listed above. In fact, the received information does not even have to be grouped into categories, as it simply can be stored as a single collection of data. Moreover, some of this information may be blocked. For example, the user may not wish to accept information from points of interest 120 where the degree of interaction between the points of interest 120 and the mobile unit 110 is limited, such as merely passing by the billboard or gift shop.

After storage, the received information can be made available to the user of the mobile unit 110 or some other authorized individual. For example, the user may access the information from the memory 220 of the mobile unit 110 or from the other unit 130. This information can be displayed in any suitable fashion. In particular, if the information has been categorized, the user may simply select a certain category from a menu, and the information associated with the points of interest 120 that met the criteria for storage in that category can be displayed. Alternatively, information can be displayed without regard to the type of category in which it was stored. Moreover, the user may place date or geographical restrictions on the information to be accessed.

As another example, the relevant information that has been retrieved can be displayed in a reverse chronological order. Additionally, this displayed information can be superimposed over a map that shows a previous path of transit for the mobile unit 110. For example and focusing on the scenario previously recited, once her scheduled appointment is over, the user of the mobile unit 110 may be interested in obtaining information about a location that she previously visited or passed by. The user may place a date restriction on a search that limits results to those obtained during her trip to the doctor's office. The information associated with the four points of interest 120 (assuming none was blocked) can be superimposed over a map that shows her path of transit. The user may then, for example, obtain the phone number, address and hours of operation of the gift shop that she passed on the way to the doctor's office.

As another example, the user may access a menu from the restaurant that she visited before her appointment, which can help her place an order in the future. For convenience, the information can be displayed on the path of transit displayed on the map in reverse chronological order (most recent points of interest listed first) to help the user's memory when determining whether a particular point of interest 120 is relevant. As such, the presently described system and method can help a user access information associated with a previously visited location. In the interest of limited memory space, the stored information can be eventually erased and replaced with more recent received information.

While the various embodiments of the present invention have been illustrated and described, it will be clear that the claimed subject matter is not so limited. Numerous modifications, changes, variations, substitutions and equivalents will occur to those skilled in the art without departing from the spirit and scope of the present invention as defined by the appended claims.

What is claimed is:

1. A method of providing information associated with a previously visited location, comprising:
at a mobile unit, monitoring the location of the mobile unit;
receiving at the mobile unit information from one or more points of interest as the mobile unit engages the points of interest, wherein the information is associated with the points of interest; and
storing the information associated with the points of interest in a database that is accessible for a predetermined amount of time after the receipt of the information.

2. The method according to claim 1, further comprising storing the information into one of a predetermined number of categories based on how the mobile unit engages the points of interest.

3. The method according to claim 2, wherein one of the categories is a first category based on:
the user of the mobile unit being at a point of interest greater than a predetermined amount of time;
the user having a scheduled appointment at a point of interest;
whether the user of the mobile unit purchased an item at a point of interest;
the frequency at which the user of the mobile unit visits a point of interest; or the user of the mobile unit listing a point of interest as worthy of storage in the first category.

4. The method according to claim 3, wherein one of the categories is a second category based on the mobile unit being at a point of interest less than a predetermined amount of time.

5. The method according to claim 4, wherein one of the categories is a third category based on how recently the mobile unit engages a point of interest.

6. The method according to claim 1, further comprising filtering the receipt of information at the mobile unit such that information from only certain types of points of interest are stored in the database.

7. The method according to claim 1, wherein storing the information further comprises storing the information in a database of a memory of the mobile unit or in a database of a memory of another device.

8. The method according to claim 1, further comprising accessing the information stored in the database at the mobile unit or at another device.

9. The method according to claim 1, wherein the information comprises a name of a business, a contact number, a Web site address, a physical address, hours of operation, a menu, accepted payment methods or type of items sold.

10. The method according to claim 1, further comprising removing the information associated with the points of interest from the database after the predetermined amount of time.

11. The method according to claim 1, wherein the points of interest include commercial establishments, residences or advertising structures.

12. The method according to claim 1, wherein receiving at the mobile unit information from one or more points of interest further comprises receiving the information over a short-range or near-field communication protocol.

13. A method of displaying points of interest, comprising:
recording a path of transit that a mobile unit has taken over the course of a predetermined amount of time or distance;
receiving information from one or more points of interest that are within an acceptable range of the path of transit, wherein the information is associated with the points of interest;
storing the information associated with the points of interest in a database; and
displaying the information associated with the points of interest in a reverse chronological order when the information is accessed from the database.

14. The method according to claim 13, further comprising sorting the information associated with the points of interest based on a degree of interaction between the mobile unit and a point of interest.

15. The method according to claim 13, further comprising selectively blocking the receipt of information from points of interest that are designated as unwanted.

16. A mobile unit for providing information associated with a previously visited location, comprising:
a location tracking unit that monitors the location of the mobile unit;
a transceiver that receives information from one or more points of information when the mobile unit engages the points of interest, wherein the information is associated with the points of interest; and
a processor, wherein the processor is communicatively coupled to the location tracking unit and the transceiver and is operable to:
push the information associated with the points of interest to a database; and
provide access to the information for a predetermined amount of time following the receipt of the information at the transceiver.

17. The mobile unit according to claim 16, wherein the database is contained within the mobile unit or the database is part of another device.

18. The mobile unit according to claim 16, further comprising a filter, wherein the filter selectively blocks the receipt of information from undesirable points of interest.

19. The mobile unit according to claim 16, further comprising a display, wherein the display shows the information associated with the points of interest in a reverse chronological order based on a path that the mobile unit travels along.

20. The mobile unit according to claim 16, wherein the mobile unit engaging the points of interest is based on a degree of interaction between the mobile unit and a point of interest.
